(19) United States
(12) Patent Application Publication
(10) Pub. No.: US 2014/0342785 A1
(43) Pub. Date: Nov. 20, 2014

(54) Portable apparatus to transport, store, and operate hands-free a cellular phone

(71) Applicant: Frank C. Saldo, Las Vegas, NV (US)

(72) Inventor: Frank C. Saldo, Las Vegas, NV (US)

(21) Appl. No.: 13/998,025

(22) Filed: Sep. 24, 2013

Related U.S. Application Data
(60) Provisional application No. 61/855,434, filed on May 15, 2013.

(51) Int. Cl. H04M 1/04

(52) U.S. Cl. CPC H04M 1/04
USPC 455/575.6

(57) ABSTRACT

A communication apparatus comprises a harness worn on the person. The harness includes a pouch and an adjustable elongate arm with a distal end which is secured to a communication device. The arm can be manipulated to stow the communication device away from the pouch and at the front an individual.

This application claims priority based on U.S. Provisional Patent Application Ser. No. 61/855,434 filed May 15, 2013.

This application relates to communication apparatus.

More particularly, the invention relates to apparatus to operate hands-free portable communication devices.

In a further respect, the invention relates to apparatus to secure and transport communication devices.

In another respect, the invention relates to apparatus worn on the person.

Those skilled in the art have for many years endeavored to discover improved methodologies and equipment for operating communication devices.

Accordingly, it would be highly desirable to provide an improved method and apparatus to facilitate operating a portable communication device.

Therefore, a principal object of the invention is to provide an improved method and apparatus for stowing, deploying, and operating a portable communication device.

This, and other and further objects of the invention will be apparent to those skilled in the art from the following detailed description thereof, taken in conjunction with the drawings, in which:

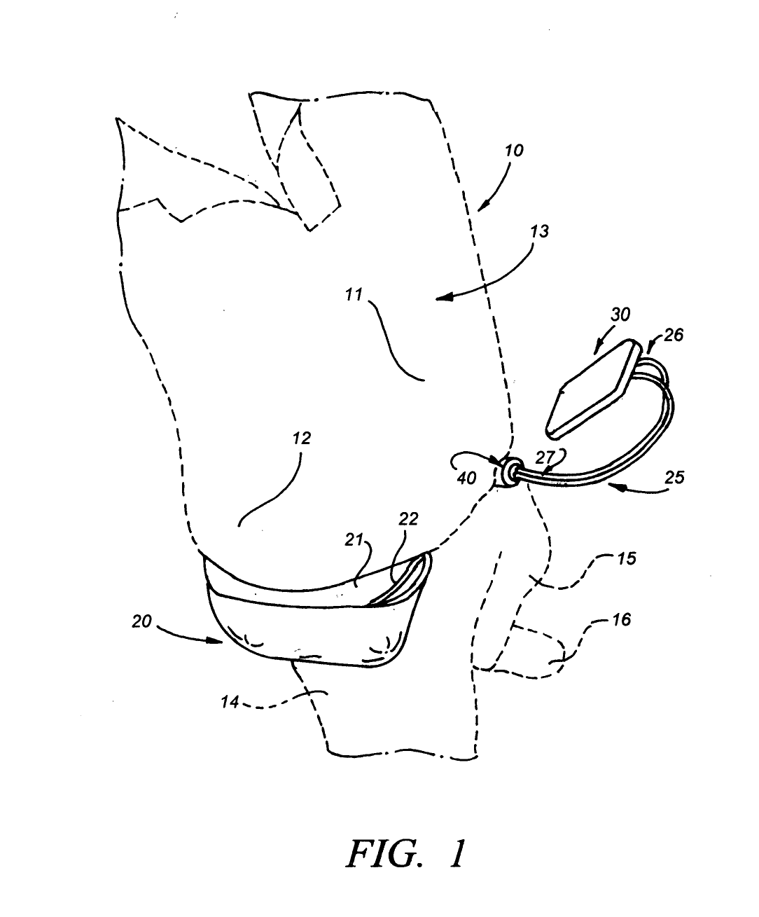

FIG. 1 is a perspective view taken from the front right side of an individual illustrating communication apparatus constructed in accordance with the invention, including a communication device spaced away from the front of the individual in position for hands-free operation;

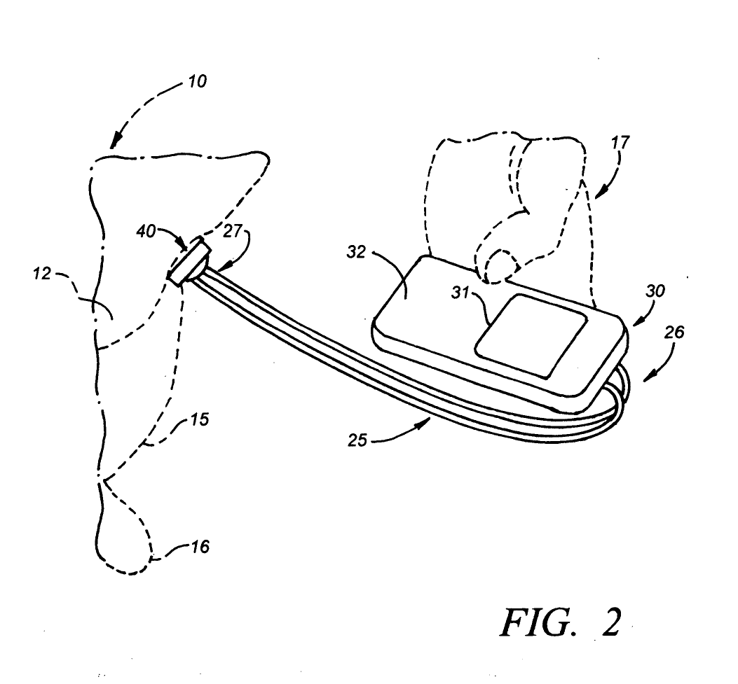

FIG. 2 is a perspective view taken from the front of an individual illustrating the manual operation of apparatus comprising part of the communication apparatus of FIG. 1;

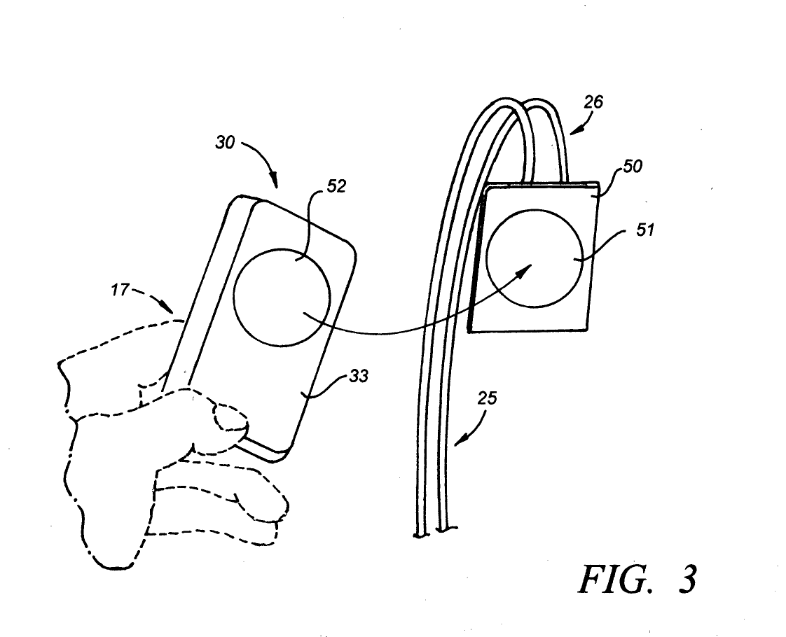

FIG. 3 is a perspective view illustrating how the communication device of FIG. 1 is removably attached to the apparatus of FIG. 1;

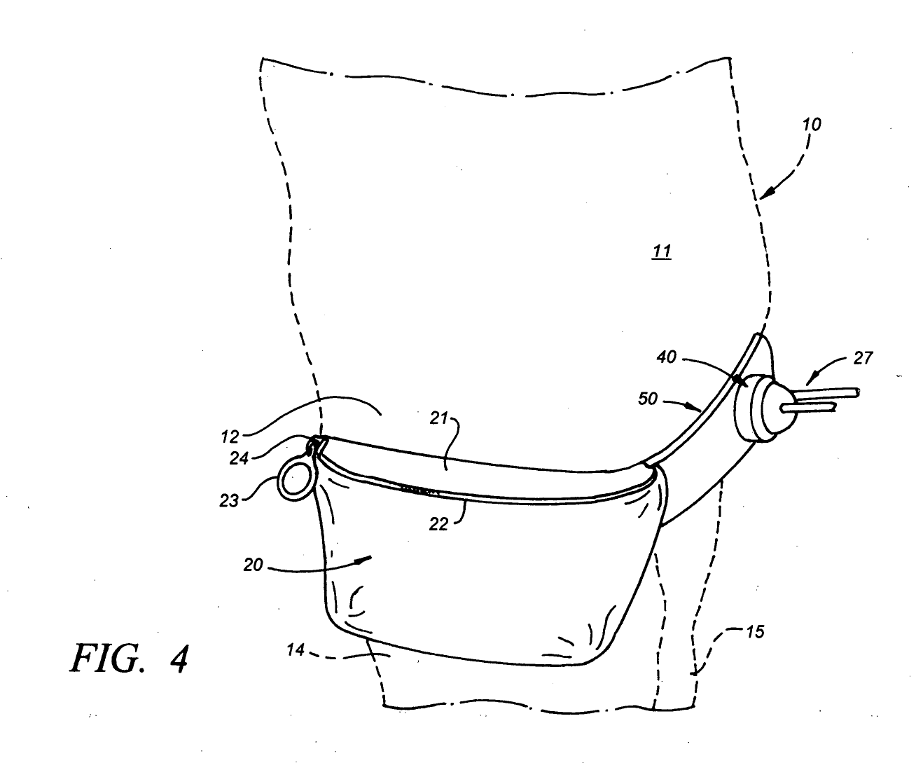

FIG. 4 is a perspective view taken from the right side of an individual and further illustrating construction of the communication apparatus of the invention;

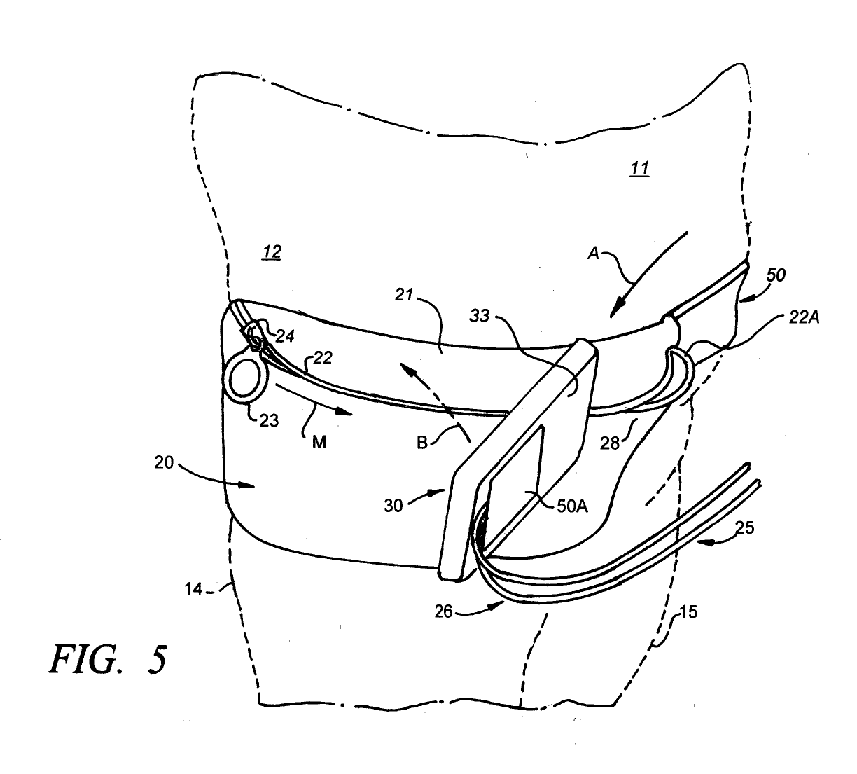

FIG. 5 is a perspective view taken from the right side of an individual and illustrating the mode of operation of the apparatus of the invention;

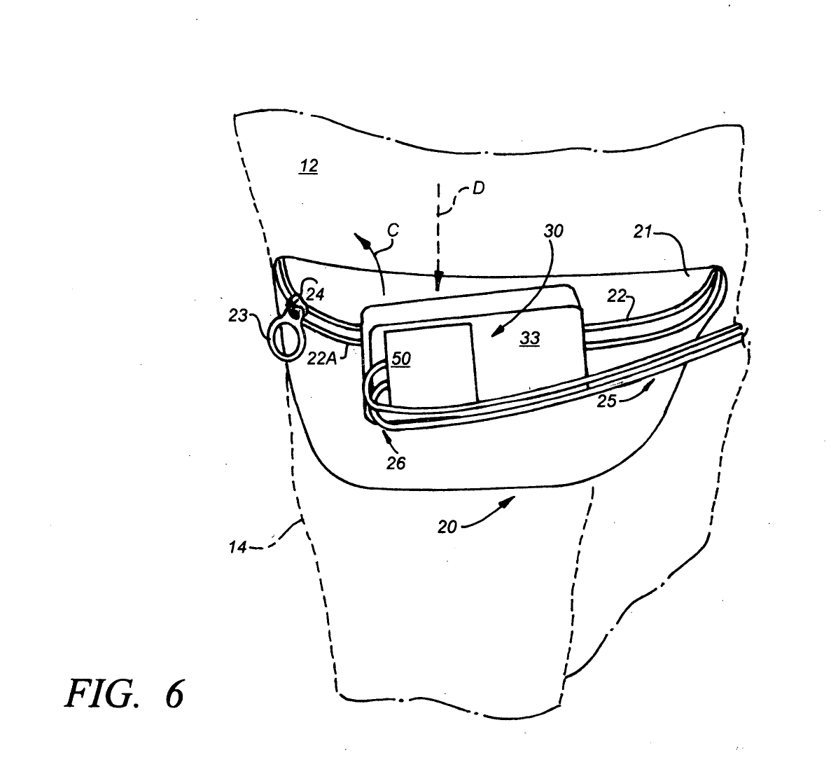

FIG. 6 is a perspective view taken from the right side of an individual and further illustrating the mode of operation of the apparatus of the invention;

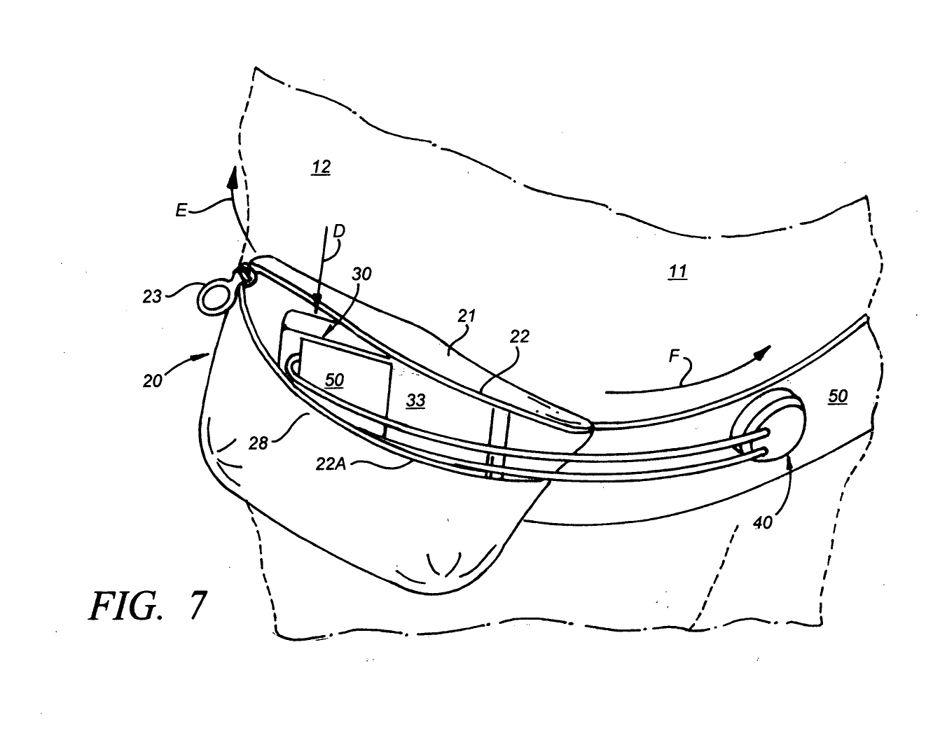

FIG. 7 is a perspective view taken from the from right side of an individual and further illustrating the mode of operation of the apparatus of the invention;

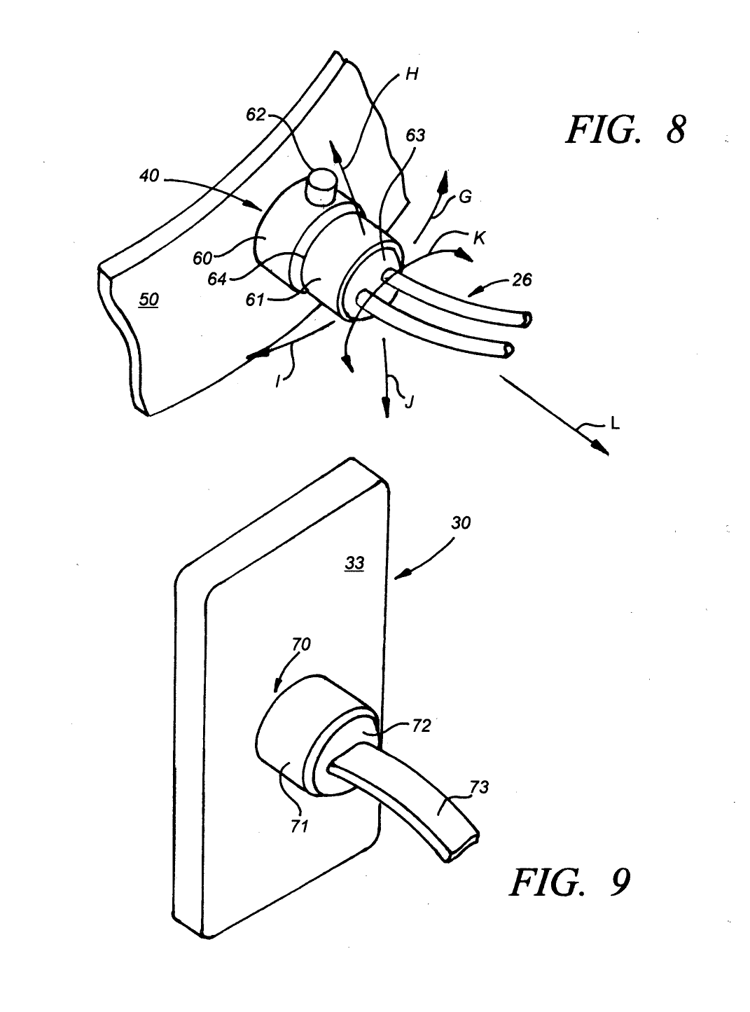

FIG. 8 is a perspective view illustrating the mode of operation of a universal joint utilized in one embodiment of the communication apparatus of the invention;

FIG. 9 is a perspective view illustrating a universal joint construction utilized on the communication device in accordance with another mode of the invention; and,

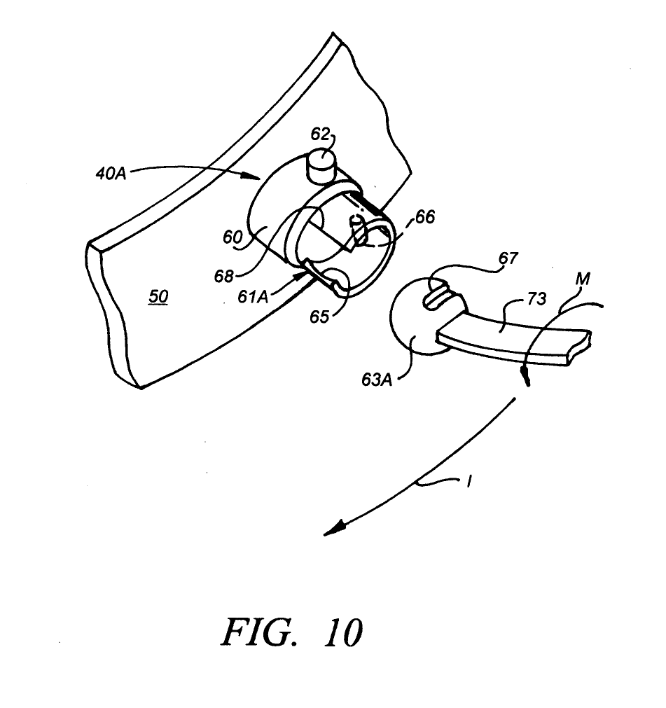

FIG. 10 is a perspective view illustrating an alternate universal joint construction utilized on a communication device in accordance with another embodiment of the invention.

Briefly, in accordance with the invention, I provide communication apparatus. The apparatus comprises a harness shaped, contoured, and dimensioned to be worn at the waist of an individual. The harness includes a pouch, clasp or other attachment means positioned at the side of the individual when the harness is worn on the individual; an elongate belt; a pliable elongate arm having a proximate end and a distal end; a first attachment structure on the distal end of the arm; a second attachment structure on the proximate end of the arm; and, a joint structure on the belt. The joint structure engages the second attachment structure such that the arm is adjustably displaceable upwardly and downwardly, and laterally between at least two operative positions, a first operative position with the distal end spaced away from and at the front of the individual, and a second operative position with the distal end laterally displaced away from the first operative position and at the side of the individual adjacent the pouch. The apparatus also includes a communication device removably secured to the first attachment structure such that when the distal end is in the first operative position, the device is spaced apart from the front of the individual and the individual can manually operate said device; and such that when the distal end is in the second operative position, the device is stowed in the pouch.

Turning now to the drawings, which are presented by way of illustration and not limitation of the invention, and in which like reference characters refer to corresponding elements throughout the several views, FIG. 1 illustrates communication apparatus constructed in accordance with one embodiment of the invention. The apparatus includes a harness shaped, contoured, and dimensioned to be worn at the waist of an individual 10.

The harness includes a pouch 20 positioned at the side 12 of the individual when the harness is worn on the individual 10; includes an elongate belt 50 that extends around the waist of the individual; includes a pliable elongate arm 25 having a proximate end 27 and a distal end 26; includes a first attachment structure 50A on the distal end 26 of the arm 25; includes a second attachment structure 61 (FIG. 8) on the proximate end 27 of the arm 25; and, includes a joint structure 60 (FIG. 8) on the belt 50 to engage the second attachment structure 61 such that the arm 25 is adjustable. Arm 25 is adjustably displaceable upwardly and downwardly, laterally, and between at least two operative positions, a first operative position with the distal end 26 spaced away from and at the front of the individual, and a second operative position with the distal end 26 laterally displaced away from the first operative position and at the side 12 of the individual 10 adjacent the pouch 20.

The communication apparatus also includes a communication device 30 removably secured to the first attachment structure 50 such that when the distal end 26 is in the (a) first operative position, the device 30 is spaced apart from the front 11 of the torso 13 of the individual 10 and the individual can view screen 31 and manually operate the device, and (b) second operative position, said device 30 is stowed in the pouch 20. FIG. 2 illustrates how device 30 can be held and manually operated by the hand 17 of an individual 10 when device 30 is positioned in front of and spaced apart from the torso 13 of an individual in the manner illustrated in FIG. 1. In FIG. 1, individual 10 includes left leg 15, right leg 14, and left foot 16.

The communication device 30 utilized in the practice of the invention presently comprises a portable device like an Android or iPhone cellular phone, but can comprise any desired communication device including, by way of example and not limitation, an iPad, ham radio, or other device that communicates via cell towers, via the Internet, via wireless signal, or via any other desired means. Importantly, device 30 is portable and can be operated manually and/or by voice command. Device 30 typically includes a microprocessor.

Device 30 is, as noted, detachably secured to the distal end 26 of arm 25. One such method of attachment includes panel structure 50 provided with a circular piece 51 of “loop” VELCRO™ fastening material. Panel structure 50 is secured to end 26 of arm 25. VELCRO™ fastening material 51 is fixedly secured to panel structure 50. Circular piece 52 of “hook” VELCRO™ fastening material is fixedly secured to the back surface 33 of device 30. Device 30 is secured detachably to structure 50 by pressing piece 52 against piece 51 such that piece 52 is generally in registration with piece 51. The diameter of piece 51 is generally equivalent to the diameter of piece 52. Any desired means can be utilized to secure device 30 to the distal end 26 of arm 25. Display screen 31 can be a touch activated screen. Device 30 can include a keyboard structure comparable to a computer keyboard, or, the keyboard can be produced on screen 31.

In FIGS. 1, 4 to 7, pouch 20 is mounted on belt 50 at a side 12 of individual 10. Pouch 20 includes top or flap 21. A first zipper “strip” 22 is secured to the peripheral edge of flap 21. A second zipper “strip” 22A (FIG. 5) is secured to the upper edge 28 of the lower portion of pouch 20. Closure member 24 is moved in conventional fashion by pulling ring 23 (and therefore member 24) in the direction of arrow M. When member 24 moves in the direction of arrow M, member 24 draws together and interlocks zipper strips 22 and 22A in conventional fashion.

The structure of arm 25 can vary as desired. Arm 25 presently consists of a pair of generally parallel wires. Arm 25 can be substantially rigid and not be resilient or pliable. In the presently preferred embodiments of the invention, however, arm 25 is pliable and resilient, i.e. arm 25 can be displaced a selected distance with causing permanent deformation, in much the way that a ruler made from a thin strip of stainless steel can be bent without permanently deforming the ruler. In many cases, a flat thin stainless steel ruler can be bent into a U-shape and still, when released, readily return—like a spring—to its normal flat configuration without permanently deforming the ruler. Arm 25 can, of course, be made of a material that can be permanently bent and deformed into one configuration and that can be permanently bent once again into a second configuration. It is, however, presently preferred that arm 25 be like a spring and be resiliently bendable such that the arm 25 will return to its original configuration after the bending force is released. In FIG. 9, arm 25 is replaced by an elongate strip or panel-shaped arm 73.

The ability to move arm 25 laterally and up and down is an important feature of the invention. One structure 40 for achieving such movement is illustrated in more detail in FIG. 8. Structure 40 includes second cylindrically shaped attachment structure 61 on the proximate end 27 of arm 25; and, includes a cylindrically shaped joint structure 60 fixedly secured to belt 50. Structure 61 slidably fits and snaps into a cylindrical aperture 64 formed in structure 60. Pressing button 62 downwardly releases structure 61 so it can be removed from joint structure 60. As would be appreciated by those of skill in the art, the shape and dimension and functioning of structures 60 and 61 can vary as desired as long as, if desired, the proximate end of arm 25 can be released and moved away from belt 50 in the direction of arrow L.

A socket formed in structure 61 pivotally receives ball 63 such that ball 63, and therefore arm 25, can be pivoted in any direction, including up in the direction of arrow H, down in the direction of arrow J, laterally in the directions of arrows I and G, and rotationally as indicated by arrows K. In FIG. 9, ball 72 and structure 71 of joint member 70 are comparable in function to structure 61 and ball 63, i.e., ball 72 pivots in structure 71 in the various directions indicated in FIG. 8 for ball 63. Structure 71 is, in the embodiment of the invention illustrated in FIG. 9, fixedly secured to the back surface 33 of device 30. Ball 72 functions in the manner of a universal joint and permits device 30 to be pivotally adjusted in a variety of directions with respect to arm 73.

FIG. 5 illustrates the initial phase of moving device 30 from the hands-free operative position of FIG. 1 to the stowed position of FIG. 7. In FIG. 5, ball 63 and arm 25 have been rotated in the direction of arrow A to move device 30 from the position illustrated in FIG. 1 to the position illustrated in FIG. 5. Once device 30 is in the position illustrated in FIG. 5, arm 25 and ball 63 are rotated in the direction of arrow I (FIG. 8) to move device 30 in the direction of arrow B (FIG. 5) and closer to pouch 20 and to the position illustrated in FIG. 6. In FIG. 6, it is assumed that ball 63 and arm 25 have reached the furthest possible extent of their travel and that ball 63 will not rotate further in the direction of arrow I; it being understood, however, that it is possible to construct structure 40 such that a ball 63 or other joint can be adjusted or pivoted until device 30 is moved to a position immediately adjacent the side 12 of an individual. For sake of the following discussion it is, however, assumed that ball 63 has, when device 30 is in the position illustrated in FIG. 6, reached the furthest extent of its travel in the direction of arrow I. Consequently, when device 30 reaches the position illustrated in FIG. 6, the pliability and spring-like resiliency of arm 25 comes into play and allows device 30 to be moved toward side 12 in the direction of arrow C until device 30 is positioned directly above pouch 20 and can be downwardly displaced in the direction of arrow D into pouch 20 to the position illustrated in FIG. 7. Once device 30 is in pouch in the manner illustrated in FIG. 7, ring 23 is pulled to draw zipper strips 22, 22A together as much as possible to secure device 30 and the distal end 26 inside pouch 20 for transport.

In an alternate embodiment of the invention, arm 25 is permanently in the position illustrated in FIG. 1 and the position of arm 25 cannot be adjusted.

In still another alternate embodiment of the invention, the position of arm 25 can be adjusted in only a single plane. This would, for example, be the case if arm 25 could only be adjusted directly toward and away from the front 12 of an individual 10.

In yet another alternate embodiment of the invention, pouch 20 is positioned at the front of or behind individual 10.

In a further embodiment of the invention, pouch 20 can slide a selected distance along belt 50 in the directions of arrows E and F in FIG. 7 either before or after device 30 is stowed in pouch 20. The shape and dimension and structure of belt 50 can vary as desired. Various belt structures, including belt buckles, are well known in the art. Similarly, the construction of pouch 20 can vary as desired as long as pouch 20 can function to stow device 30 in a relatively fixed position for transport. Pouch 20 may, for example, comprise a relatively open skeletal structure which is similar to some polymer holsters and which permits portions of device 30 to be readily viewed by an observer but which still functions to engage device 30 and to secure device 30 in a desired fixed position.

In still a further embodiment of the invention, the harness structure is not mounted around the waist, but is instead mounted over the shoulder(s) and around the torso in the manner of a backpack strap unit or of a holster strap assembly that secures a gun holster at the side under the arm of an individual.

In an alternate embodiment of the invention, the length of pliable elongate arm 25 is adjustable. Any desired construct can be used to produce an adjustable arm 25. For example, arm 25 can incorporate a telescoping structure which permits the length of arm 25 to be adjusted. Or, arm 25 can comprise a plurality of segments which can be snapped together to form arm 25. Once arm 25 is assembled, arm 25 is shortened by removing one or more segments. Alternatively, one or more additional segments is incorporated in arm 25 to increase the length of arm 25. Another way to permit the length of arm 25 to be adjusted is to construct arm 25 so it folds. One such folding construct permits arm 25 to fold like an accordion. And so on.

Pouch 20 is constructed as desired to be mounted on belt 50. In one pouch construction, loops are provided on the back of pouch 20. Belt 50 threads through the loops such that the loops, and therefore pouch 20, slide along belt 50. In another belt construction, pouch 20 is fixedly secured to belt 50. Pouch 20 can include a closure like flap 21 or can be open, in a manner similar to a jar without a lid.

The interior of pouch 20 can include a clasp or other attachment means to engage the distal end 26 of arm 25 to secure end 26 inside pouch 20. The clasp or other attachment means preferably can be readily disengaged from end 26 so that device 30 can be quickly deployed from pouch 20. If desired, a clasp or other attachment means can be secured to belt 50 in place of pouch 20 and used to removably detachably secure distal end 26 of arm 25 adjacent belt 50.

In FIG. 1, the distal end 26 of arm 25 extends downwardly past the top of device 30 to an attachment area on the back of device 30. As would be appreciated by those of skill in the art, the distal end 26 can instead extend upwardly past the bottom of device 30 to an attachment area on the back of device 30, or, can extend along one side of device 30 and then laterally past a side of the device 30 and to an attachment area on the back of device 30.

A particular advantage of having distal end 26 extend underneath and spaced apart from device 30, and extend downwardly past the top of device 30 in the manner illustrated in FIG. 1, is that a user's hands and some fingers can readily grasp the bottom, sides, and back of device 30 while some of the user's other fingers are operating buttons or a touch screen on the front of device 30. Another advantage of having distal end 26 extend beneath, spaced apart from, and downwardly past the top of device 30 in the manner illustrated in FIG. 1 is that it permits unobstructed lateral movement by the left, right, or both hands under the device 30 and across the body in front of the torso. Such unobstructed lateral movement permits the user's hands to be used for other purposes while device 30 is positioned in front of the torso.

Structure 40 can be secured to belt 50 utilizing any desired construction. In a first construction, structure 40 is fixedly attached to a plate which is secured to belt 50.

In a second construction, structure 40 is attached directly to belt 50.

In a third construction, structure 40 is fixedly connected to a hollow metal loop. The metal loop is shaped and dimensioned to fit over and slide along belt 50 to any desired position on belt 50. One virtue of the metal loop-structure 40 combination is that it can be sold separately and slidably mounted on a belt which an individual already owns. Similarly, If joint structure 60 (FIG. 8) is fixedly connected to the metal loop, then the metal loop-joint structure 60 can be sold separately; and, the attachment structure 61 and arm 25 can be sold separately. A user can purchase the metal loop-joint structure 60 and then purchase a desired attachment structure 61 and arm 25. The metal loop can, instead of being made of metal, be made of any other desired material(s).

In FIG. 10, structure 40A includes second cylindrically shaped attachment structure 61A on the proximate end of arm 73; and, includes a cylindrically shaped joint structure 60 fixedly secured to belt 50. Structure 61A slidably fits and snaps into a cylindrical aperture formed in structure 60. Pressing button 62 downwardly releases structure 61A so it can be removed from joint structure 60. As would be appreciated by those of skill in the art, the shape and dimension and functioning of structures 60 and 61A can vary as desired as long as, if desired, the proximate end of arm 73 can be released and move away from belt 50.

An arcuate inner socket surface 65 formed in structure 61A pivotally receives ball 63A such that ball 63A, and therefore arm 73, can be pivoted in any direction, including up, down, laterally, and rotationally.

Structure 40A in FIG. 10 is similar to structure 40 in FIG. 8. In FIG. 10, however, a slot 68 is formed in attachment structure 61A and is shaped and dimensioned to function to increase the rotational range of motion of ball 63A in structure 61A so that arm 73 can, after it is laterally moved in the direction of arrow I, be rotated in the direction of arrow M and then pivoted downwardly past a generally horizontal orientation. In FIGS. 5 and 6, arm 25 is in a generally horizontal orientation from which arm 25 (and device 30) is pivoted downwardly in the direction of arrow D in order to insert device 30 in pouch 20.

Another distinction between structure 40A and structure 40 is that structure 40A includes a fixed downwardly projecting finger 66 which is fixedly secured to inner socket surface 65. Finger 66 extends into slot 67 formed in ball 63A. Slot 67 is shaped and dimensioned such that it, in combination with finger 66, defines the path of travel of arm 73 when arm 73 moved from a deployed position (similar to that illustrated in FIG. 1) to a stowed position (similar to that illustrated in FIG. 7). Consequently, when arm 73 is moved (initially in the direction of arrow I in FIG. 10), slot 67 slides over fixed finger 66 and arm 73 moves along a path of travel which is defined by slot 67 and which causes device 30 ultimately to end up stowed in pouch 20 in the manner illustrated in FIG. 7. In other words, finger 66 and slot 67 are operatively associated to force arm 73 to move along a selected predictable path of travel which is repeated each time arm 73 moves from a deployed to a stowed position, and vice-versa. Finger 66 and slot 67 also function to prevent arm 73 from straying or moving away from the selected path of travel to undesired positions and orientations above or below the selected path of travel.

As noted above, in some embodiments of the invention, pouch 20 is not utilized and, instead, attachment means is provided which is secured to belt 50 and which permits distal end 26 of arm 25 to be detachably secured to the attachment means adjacent belt 50. In such embodiments, when arm 73 is moved (initially in the direction of arrow I in FIG. 10), slot 67 slides over fixed finger 66 and arm 73 moves along a path of travel which is defined by slot 67 and which causes distal end 26 of arm 25 (or device 30) ultimately to end up removably secured to said attachment means adjacent belt 50.

Having described my invention in such terms as to enable those skilled in the art to understand and practice it, and having described the presently preferred embodiments thereof, I claim:

1. A communication apparatus, comprising
(a) a harness shaped, contoured, and dimensioned to be worn at the waist of an individual, said harness including
(i) a pouch positioned at the side of the individual when said harness is worn on the individual,
(ii) an elongate belt,
(iii) a pliable elongate arm having a proximate end and a distal end,
(iv) a first attachment structure on said distal end of said arm,
(v) a second attachment structure on said proximate end of said arm,
(vi) a joint structure on said belt to engage said second attachment structure such that said arm is adjustably displaceable
upwardly and downwardly, and
laterally
between at least two operative positions,
a first operative position with said distal end spaced away from and at the front of the individual, and
a second operative position with said distal end laterally displaced away from said first operative position and at said side of the individual adjacent said pouch,
(b) a communication device removably secured to said first attachment structure such that when said distal end is in said
(i) first operative position, said device is spaced apart from the front of the individual and the individual can manually operate said device; and
(ii) second operative position, said device is stowed in said pouch.
